(19) United States
(12) Patent Application Publication
(10) Pub. No.: US 2014/0050946 A1
(43) Pub. Date: Feb. 20, 2014

(54) PROTECTION APPARATUS FOR BATTERY PACK AND BATTERY PACK HAVING THE SAME

(71) Applicant: Samsung SDI Co., Ltd., Yongin-city (KR)

(72) Inventor: Bo-Hyun Byun, Yongin-city (KR)

(21) Appl. No.: 13/838,179

(22) Filed: Mar. 15, 2013

Related U.S. Application Data
(60) Provisional application No. 61/684,034, filed on Aug. 16, 2012.

(51) Int. Cl. H01M 2/34

(52) U.S. Cl. CPC H01M 2/348
USPC 429/7

(57) ABSTRACT

A protection apparatus for a battery pack and a battery pack having the same are disclosed. In one aspect, the apparatus includes 1) a bare cell, 2) a protection circuit module positioned on the bare cell, and wherein the protection circuit module comprises first and second contact pads and 3) a protection apparatus positioned on the protection circuit module. The protection apparatus includes 1) a body portion having first and second surfaces opposing each other, 2) a first connecting portion positioned on the first surface of the body portion, wherein at least part of the first connecting portion is disposed adjacent to the center of the body portion and directly contacts the first contact pad and 3) a second connecting portion positioned on the second surface of the body portion.

### CROSS-REFERENCE TO RELATED APPLICATIONS

This application claims priority to U.S. Provisional No. 61/684,034 filed Aug. 16, 2012, which is hereby incorporated by reference in its entirety.

### BACKGROUND

1. Field

The described technology generally relates to a protection apparatus for a battery pack and a battery pack having the same.

2. Description of the Related Technology

Recently, battery packs have been variously used as power sources of potable electronic devices. As the portable electronic devices are used in various fields, demands on battery packs are rapidly increased. The battery packs can be charged/discharged multiple times, and accordingly are economically efficient and environmentally beneficial.

### SUMMARY

One inventive aspect is a protection circuit for a battery and a battery pack having the same, which can achieve a small size and a light weight by employing a new structure.

Another inventive aspect is a protection apparatus for a battery pack and a battery pack having the same, which can improve its safety.

Another inventive aspect is a protection apparatus for a battery pack, including: a body portion; a first connecting portion positioned on one surface of the body portion so as to come in surface contact with a first terminal of the battery pack, wherein the first terminal and the body portion are electrically connected by the first connecting portion; a second connecting portion positioned on the other surface of the body portion; and an extending portion bent and extended from the second connecting portion, wherein the second connection portion and a second terminal of the battery pack are electrically connected by the extending portion.

The first and second terminals may be formed on a protection circuit module of the battery pack.

The first connecting portion and an end portion of the extending portion may be positioned on the same plane.

The extending portion may be spaced apart from the body portion.

The resistance of the body portion may be changed by a temperature measured by the body portion.

30% or more of the first connecting portion may come in surface contact with the first terminal.

A groove portion at which solder for connecting the second terminal and the extending portion may be formed in the end portion of the extending portion.

A connection region of the second connecting portion, connected to the extending portion, may be narrower than the region except the connection region of the second connecting portion.

A bending cut-away line may be formed in a region at which the extending portion is bent.

The end portion of the extending portion may come in surface contact with the second terminal.

Another inventive aspect is a battery pack having a protection apparatus, including: a bare cell; a protection circuit module positioned on the bare cell; and the protection apparatus positioned on the protection circuit module, wherein the protection apparatus includes a body portion; a first connecting portion positioned on one surface of the body portion so as to come in surface contact with a first terminal of the battery pack, wherein the first terminal and the body portion are electrically connected by the first connecting portion; a second connecting portion positioned on the other surface of the body portion; and an extending portion bent and extended from the second connecting portion, wherein the second connection portion and a second terminal of the battery pack are electrically connected by the extending portion.

The first and second terminals may be formed on a protection circuit module of the battery pack.

The first and second terminals may be positioned on the same plane.

The extending portion may be spaced apart from the body portion.

The resistance of the body portion may be changed by a temperature measured by the body portion.

30% or more of the first connecting portion may come in surface contact with the first terminal.

A groove portion at which solder for connecting the second terminal and the extending portion may be formed in the end portion of the extending portion.

A connection region of the second connecting portion, connected to the extending portion, may be narrower than the region except the connection region of the second connecting portion.

A bending cut-away line may be formed in a region at which the extending portion is bent.

The end portion of the extending portion may come in surface contact with the second terminal. Another aspect is a battery pack, comprising: a bare cell; a protection circuit module positioned on the bare cell, and wherein the protection circuit module comprises first and second contact pads; and a protection apparatus positioned on the protection circuit module, wherein the protection apparatus comprises: a body portion having first and second surfaces opposing each other; a first connecting portion positioned on the first surface of the body portion, wherein at least part of the first connecting portion is disposed adjacent to the center of the body portion and directly contacts the first contact pad; and a second connecting portion positioned on the second surface of the body portion.

In the above battery pack, the protection circuit module comprises top and bottom surfaces opposing each other, wherein the bottom surface of the protection circuit module is positioned on the bare cell, and wherein the first and second contact pads are formed on the top surface of the protection circuit module. The above battery pack further comprises an extension to the second connecting portion and directly contacting the second contact pad. In the above battery pack, the extension is non-linear. In the above battery pack, the extension has a substantially zigzag shape. In the above battery pack, the extension comprises: a first extending portion extending from the second connecting portion toward the protection circuit module; and a second extending portion extending from the first extending portion in a direction substantially parallel with the protection circuit module, wherein the second extending portion contacts the second contact pad.

In the above battery pack, the first extending portion does not contact the second contact pad. In the above battery pack, the distance between the protection circuit module and the first connecting portion is substantially the same as the distance between the protection circuit module and the second extending portion. In the above battery pack, at least one of the first connecting portion and the second extending portion is substantially flat.

In the above battery pack, the extension comprises: a first extending portion extending from the second connecting portion in a first direction; and a second extending portion extending from the first extending portion in a second direction that crosses the first direction so as to extend away from the body portion, wherein the second extending portion contacts the second contact pad.

In the above battery pack, the first and second directions are substantially perpendicular to each other. In the above battery pack, the first connecting portion has a width less than the length, and wherein the first connecting portion and the second extending portion are substantially aligned with each other in the direction of the length of the first connecting portion. In the above battery pack, a gap is formed between a side surface of the body portion and the first extending portion. In the above battery pack, a notch is formed in the second extending portion.

In the above battery pack, the second connecting portion has a width less than the length, wherein the second connecting portion has a connection region adjacent to the first extending portion, and wherein the width of the connection region is less than the width of the remaining second connecting portion. In the above battery pack, an edge is formed by at least one of 1) the connection between the second connecting portion and the first extending portion and 2) the connection between the first extending portion and the second extending portion. In the above battery pack, the first connecting portion has i) a top surface at least part of which contacts the first surface of the body portion and ii) a bottom surface at least part of which contacts the first contact pad, and wherein at least about 30% of the bottom surface of the first connecting portion contacts the first contact pad.

In the above battery pack, the resistance of the body portion is configured to change based on a temperature of the bare cell. In the above battery pack, each of the body portion and the first connecting portion has a width less than the length, and wherein the length of the body portion is substantially the same as that of the first connecting portion. In the above battery pack, part of the second connecting portion does not contact the second surface of the body portion.

### BRIEF DESCRIPTION OF THE DRAWINGS

FIG. 1 is a perspective view of a protection apparatus for a battery pack according to an embodiment.

FIG. 2 is a sectional view of the protection apparatus shown in FIG. 1.

FIG. 3 is a sectional view showing a state in which the protection apparatus shown in FIG. 1 is mounted on a protection circuit module of the battery pack.

FIGS. 4 and 5 are perspective views of a protection apparatus for a battery pack according to another embodiment.

FIG. 6 is a perspective view of a battery pack having a protection apparatus according to an embodiment.

FIG. 7 is an exploded perspective view of the battery pack having the protection apparatus shown in FIG. 6.

FIG. 8 is a sectional view of the battery pack having the protection apparatus shown in FIG. 6.

### DETAILED DESCRIPTION

As electronic devices become smaller and lighter, the size and weight of their associated battery packs must also be reduced. However, since the battery pack will normally contain a highly reactive material such as lithium, the safety of the battery pack may be compromised during downsizing. Accordingly, research has been directed to development of a battery pack that satisfies both size and safety criteria. Often, a protection circuit and housing is adopted in small battery packs.

In the following detailed description, only certain embodiments have been shown and described, simply by way of illustration. As those skilled in the art would realize, the described embodiments may be modified in various different ways, all without departing from the spirit or scope of the present. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Hereinafter, embodiments will be described in detail with reference to the accompanying drawings.

Protection Apparatus for Battery Pack

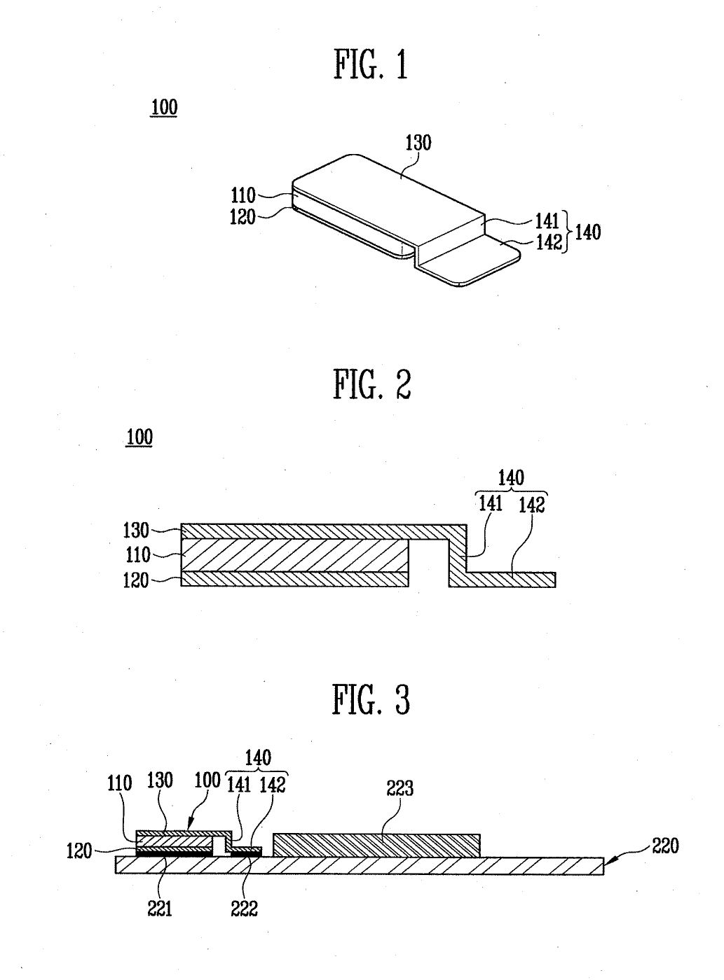

FIG. 1 is a perspective view of a protection apparatus 100 for a battery pack according to an embodiment. FIG. 2 is a sectional view of the protection apparatus 100 shown in FIG. 1. Hereinafter, the protection apparatus 100 will be described with reference to FIGS. 1 and 2.

As shown in FIGS. 1 and 2, the apparatus 100 may include a body portion 110, a first connecting portion 120 positioned on one surface of the body portion 110, a second connecting portion 130 positioned on the other surface of the body portion 110, and an extending portion 140 bent and extended from the second connecting portion 130.

The body portion 110 is a member of which resistance is changed depending on temperature, and may form the basis of the protection apparatus 100.

Here, the resistance of the body portion 110 may be changed based at least in part on a change in the temperature of the battery pack. The body portion 110 may include, for example, a positive temperature coefficient (PTC) element. For example, if the temperature of the battery pack is increased, the resistance of the body portion 110 may be increased together with the temperature. If heat is excessively generated from the battery pack, the body portion 110 may cut off current flowing through the first and second connecting portions 120 and 130.

Meanwhile, the body portion 110 may be implemented to measure the temperature of a bare cell in the battery pack.

FIG. 3 is a sectional view showing a state in which the protection apparatus 100 shown in FIG. 1 is mounted on a protection circuit module 200 of the battery pack. Hereinafter, the first connecting portion 120, the second connecting portion 130 and the extending portion 140 in the protection apparatus 100 will be described in detail with reference to FIG. 3.

The first connecting portion 120 may be positioned on the one surface of the body portion 110, and may come in surface contact with a first terminal (or a first contact pad) 221 of the battery pack.

Here, the first connecting portion 120 may be formed to have a width substantially equal to or narrower than that of the body portion 110. The first connecting portion 120 may not protrude to an outside of the body portion 110. Therefore, in a case where the protection apparatus 100 is viewed in the direction in which the second connecting portion 130 is positioned, the first connecting portion 120 may not be viewed.

Meanwhile, the first connecting portion 120 may be electrically connected to the first terminal 221 formed on the protection circuit module 220. In this case, the first connecting portion 120 may come in surface contact with the first terminal 221. That is, the first connecting portion 120 may be implemented in the shape of a flat plate. One surface of the first connecting portion 120 may be connected to the body portion 110, and the other surface of the first connecting portion 120 may be connected to the first terminal 221. Thus, the first connecting portion 120 may allow the first terminal 221 and the body portion 110 to be electrically connected therethrough. To this end, the first connecting portion 120 may be made of, for example, an electrical conductive metal such as gold, silver, copper or nickel.

In one embodiment, about 30% or more of the first connecting portion 120 comes in contact with the first terminal 221. In a case where the first connecting portion 120 comes in surface contact with the first terminal 221, its electrical safety is improved, and the body portion 110 can more precisely measure the temperature of the battery pack through the first terminal 221. The first connecting portion 120 may be connected to the second terminal 221 through solder, for example.

The second connecting portion 130 may be positioned on the other surface of the body portion 110, i.e., the opposite side of the first connecting portion 120. The extending portion 140 may be extended from the second connecting portion 130 so as to electrically connect the second connecting portion 130 and a second terminal (or a second contact pad) 222 of the battery pack.

Here, like the first connecting portion 120, the second connecting portion 130 may be implemented in the shape of a flat plate, for example. In this case, the second connecting portion 130 may be wider than the first connecting portion 120 or the body portion 110. That is, the second connecting portion 130 is protruded from the body portion 110, and accordingly, the extending portion 140 extended from the second connecting portion 130 can be spaced apart from the body portion 110. Meanwhile, the second portion 130 may electrically connect the battery pack and the body portion 110 through the extending portion.

The extending portion 140 may have a substantially zigzag or staircase shape. The extending portion 140 may also be non-linear. For example, the extending portion 140 is bent and extended from the second connecting portion 130. One end portion of the extending portion 140 may be connected to the second connecting portion 130, and the other end portion of the extending portion 140 may be connected to the second terminal 222 of the battery pack. For example, the extending portion 140 may be electrically connected to the second terminal 222 formed on the protection circuit module 220 in the battery pack, and an electrical signal generated from the second terminal 222 may be transferred to the body portion 110 through the second connecting portion 130. The extending portion 140 may be spaced apart from the body portion 110 as described above, and accordingly, it is possible to prevent the extending portion 140 from being short-circuited with the body portion.

Meanwhile, the other end portion of the extending portion 140 may be implemented to come in surface contact with the second terminal 222. For example, the extending portion 140 may include a first extending portion 141 substantially vertically bent from the second connecting portion 130, and a second extending portion 142 substantially horizontally bent from the first extending portion 141. In this case, the second extending portion 142 may come in contact with the second terminal 222. However, the shape of the extending portion 140 is not limited thereto, and may be bent to be rounded so that the other end portion of the extending portion comes in surface contact with the second terminal 222. The extending portion 140 may be connected to the second terminal 222 through solder, for example.

The second connecting portion 130 and the extending portion 140 may be integrally formed, or may be connected through a separate member.

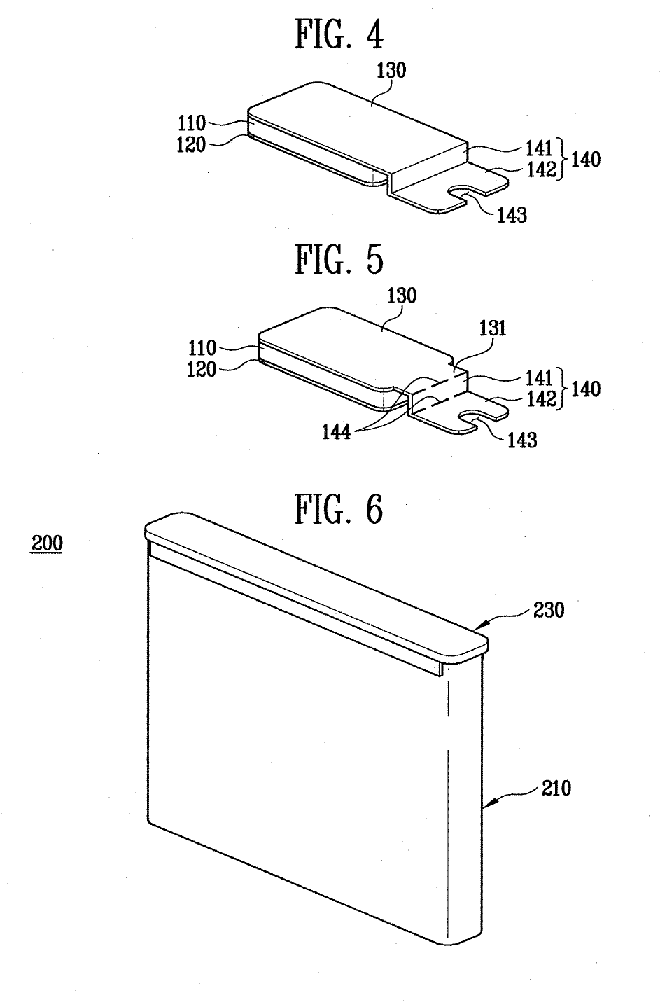

FIGS. 4 and 5 are perspective views of a protection apparatus for a battery pack according to another embodiment. Hereinafter, the protection apparatus according to this embodiment will be described with reference to FIGS. 4 and 5.

As shown in. FIG. 4, a groove portion 143 may be formed in an end portion of the second extending portion 142.

In a case where the extending portion 140 and the second terminal 222 are connected through, for example, solder, the groove portion 143 enables the solder to be well massed so that the connection between the extending portion 140 and the second terminal 222 is more firmly implemented. As shown in FIG. 4, the groove portion 143 may include not only a shape in which a portion of the end portion of the second extending portion 142 is cut away but also a hole shape passing through the end portion of the second extending portion 142.

As shown in FIG. 5, a connection region 131 of the second connecting portion 130, connected to the extending portion 140, may be narrower than the region except for the connection region 131 of the second connecting portion 130. When the extending portion 140 is bent from the second connecting portion 130, the width of the bent portion is decreased, so that the bending of the second connecting portion 130 can be more easily performed.

Meanwhile, bending cut-away lines 144 may be respectively formed in the regions at which the extending portion 140 is bent, e.g., at the point at which the first extending portion 141 and the second connecting portion 130 meet each other and the point at which the first and second extending portions 141 and 142 meet each other. Accordingly, the bending of the extending portion 140 can be more easily performed.

In this case, the groove portion 143 may be formed in the end portion of the second extending portion 142, or may not be formed in the end portion of the second extending portion 142.

Battery Pack having Protection Apparatus

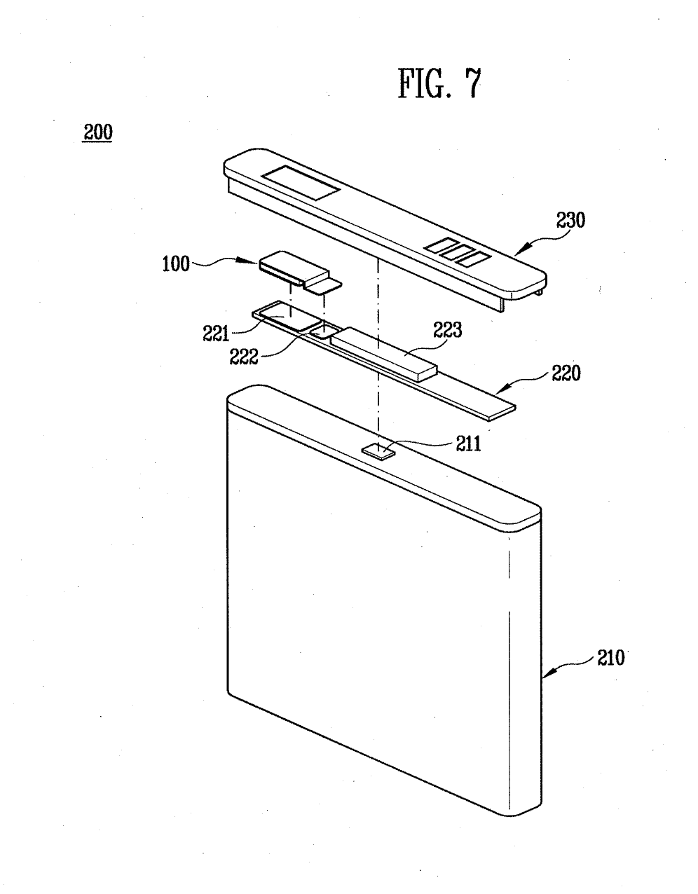

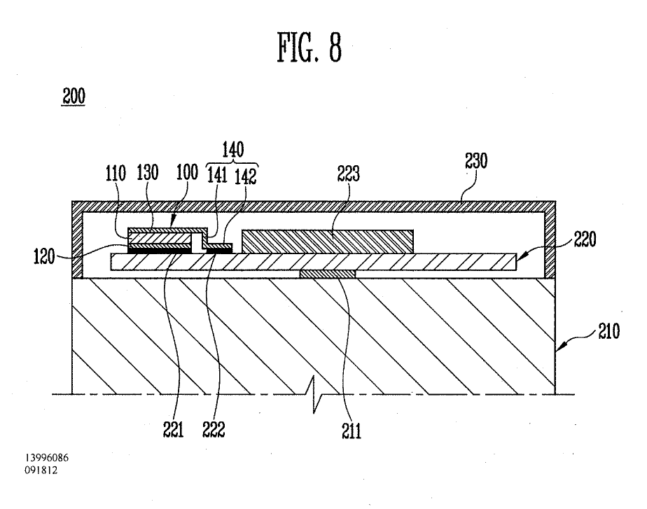

FIG. 6 is a perspective view of a battery pack 200 having a protection apparatus according to an embodiment. FIG. 7 is an exploded perspective view of the battery pack 200 having the protection apparatus shown in FIG. 6. FIG. 8 is a sectional view of the battery pack 200 having the protection apparatus shown in FIG. 6. Hereinafter, the battery pack 200 having the protection apparatus according to this embodiment will be described with reference to FIGS. 6, 7 and 8.

Here, the protection apparatus of the battery pack 200 may be the protection apparatus shown in FIGS. 1 to 5.

As shown in FIGS. 6 and 7, the battery pack having the protection apparatus 100 may include a bare cell 210, a protection circuit module 220 positioned on the bare cell 210, and the protection apparatus positioned on the protection circuit module 220.

The bare cell 210 may generate electrochemical energy through the movement of ions or electrons.

Here, the bare cell 210 may be manufactured by accommodating an electrode assembly and an electrolyte in a battery case. Here, the electrode assembly is formed by winding or stacking a positive electrode plate, a negative electrode plate and a separator interposed between the electrode plates. The electrode assembly generates energy by an electrochemical reaction between the electrode assembly and the electrolyte, and the generated energy is supplied to the outside through an electrode tab or the like. For example, the battery case may be a pouch-type, prism-type or cylinder-type battery case.

The protection circuit module 220 may be positioned on the bare cell 210 so as to control voltage or current in charging and discharging of the bare cell 210.

The protection circuit module 220 may be implemented as a circuit board having a circuit pattern formed therein, and various electronic components 223 may be mounted on one surface of the protection circuit module 220. Here, the electronic components 223 may be a field effect transistor (FET), an integrated circuit (IC), and the like. The electronic components 223 may function to control the electrode assembly in the bare cell 210 or to cut off a circuit when an abnormal operation of the electrode assembly. The circuit board of the protection circuit module 220 includes a switching circuit so that the switching circuit and the electronic components can more efficiently control or protect the battery pack 200. Specifically, the protection circuit module 220 can prevent the deterioration of explosion, overheating, leakage and charging/discharging characteristics of the battery pack 200 by blocking overcharge, overdischarge, short circuit or reverse voltage of the battery pack 200. Further, the protection circuit module 220 can remove or substantially reduce risk factors and extend the lifetime of the battery pack by prevent the degradation of electrical performance, abnormal operation, and the like.

The protection apparatus 100 may be positioned on the protection circuit module 220 so as to sense a temperature of the battery pack 200 and to cut off current by increasing resistance when the temperature increases.

In a certain protection apparatus, the PTC element was positioned between the protection circuit module and the bare cell, i.e., on the bottom surface of the protection circuit module, and therefore, a space corresponding to the thickness of the PCT element positioned between the protection circuit module and the bare cell was required. However, in this embodiment, the protection apparatus 100 is not positioned on the bottom surface of the protection circuit module 220 but positioned on the top surface of the protection circuit module 220, so that the space between the protection circuit module 220 and the bare cell 210 is not required. That is, it can be seen that the bare cell 210 and the protection circuit module 220 are adhered closely to each other.

Thus, the miniaturization of the battery pack 200 can be implemented as wide as the space. Further, since the space does not come off, the safety of the battery pack 200 can be improved.

Meanwhile, the protection apparatus 100 may include a body portion 110, a first connecting portion 120, a second connecting portion 130 and an extending portion 140. In this case, the first connecting portion 120 comes in surface contact with a first terminal 221, and the extending portion 140 extended from the second connecting portion 130 may be connected to the second terminal 222 of the protection circuit module 220. In a certain protection apparatus, the two terminals of the protection circuit module having the PCT element connected thereto existed on different surfaces from each other, and therefore, the PCT element was positioned on the bottom surface of the protection circuit module. However, in the protection apparatus 100 according to this embodiment, the first and second terminals 221 and 222 to which the respective first and second connecting portions 120 and 130 are connected may be formed on the same plane of the protection circuit module 220, i.e., on the top surface of the protection circuit module 220. In other words, the first connecting portion 130 and an end portion of the extending portion 140 may be positioned on the same plane, and accordingly, the space between the protection circuit module 220 and the bare cell 210 can be reduced as compared with the conventional space.

The first terminal 221 may be electrically connected adjacent to a negative electrode terminal 211 of the bare cell 210. However, the present invention is not limited to the case where the first terminal 221 is formed on the protection circuit module 220. For example, the first terminal 221 may be the negative electrode terminal 211 of the bare cell 210. The first terminal 221 may come in surface contact with the first connecting portion 120 of the protection apparatus 100 by forming a through-hole in the protection circuit module 220 and exposing the negative electrode terminal 211 through the through-hole.

Meanwhile, a top cover 230 is positioned on the top of the protection circuit module 220 having the protection apparatus 100 mounted thereon so as to protect the protection apparatus 100 of the battery pack 200 and the protection circuit module 220.

According to at least one of the disclosed embodiments, the first connecting portion of the protection apparatus is connected to the first terminal, and the second connecting portion is connected to the second terminal through the extending portion, so that it is possible to implement the reduced size and weight of the battery pack while improving the safety of the battery pack.

Further, the first connecting portion of the protection apparatus comes in surface contact with the first terminal, so that it is possible to improve the connection between the protection apparatus and the battery pack. Furthermore, the body portion more precisely measures a temperature of the battery pack, thereby improving the safety of the battery pack.

While the above embodiments have been described in connection with the accompanying drawings, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery pack, comprising:
a bare cell;
a protection circuit module positioned on the bare cell, and wherein the protection circuit module comprises first and second contact pads; and
a protection apparatus positioned on the protection circuit module,
wherein the protection apparatus comprises:
a body portion having first and second surfaces opposing each other;
a first connecting portion positioned on the first surface of the body portion, wherein at least part of the first connecting portion is disposed adjacent to the center of the body portion and directly contacts the first contact pad; and
a second connecting portion positioned on the second surface of the body portion.

2. The battery pack of claim 1, wherein the protection circuit module comprises top and bottom surfaces opposing each other, wherein the bottom surface of the protection circuit module is positioned on the bare cell, and wherein the first and second contact pads are formed on the top surface of the protection circuit module.

3. The battery pack of claim 1, further comprising an extension to the second connecting portion and directly contacting the second contact pad.

4. The battery pack of claim 3, wherein the extension is non-linear.

5. The battery pack of claim 3, wherein the extension has a substantially zigzag shape.

6. The battery pack of claim 3, wherein the extension comprises:
a first extending portion extending from the second connecting portion toward the protection circuit module; and
a second extending portion extending from the first extending portion in a direction substantially parallel with the protection circuit module, wherein the second extending portion contacts the second contact pad.

7. The battery pack of claim 6, wherein the first extending portion does not contact the second contact pad.

8. The battery pack of claim, 6, wherein the distance between the protection circuit module and the first connecting portion is substantially the same as the distance between the protection circuit module and the second extending portion.

9. The battery pack of claim 6, wherein at least one of the first connecting portion and the second extending portion is substantially flat.

10. The battery pack of claim 3, wherein the extension comprises:
a first extending portion extending from the second connecting portion in a first direction; and
a second extending portion extending from the first extending portion in a second direction that crosses the first direction so as to extend away from the body portion, wherein the second extending portion contacts the second contact pad.

11. The battery pack of claim 10, wherein the first and second directions are substantially perpendicular to each other.

12. The battery pack of claim 10, wherein the first connecting portion has a width less than the length, and wherein the first connecting portion and the second extending portion are substantially aligned with each other in the direction of the length of the first connecting portion.

13. The battery pack of claim 10, wherein a gap is formed between a side surface of the body portion and the first extending portion.

14. The battery pack of claim 10, wherein a notch is formed in the second extending portion.

15. The battery pack of claim 10, wherein the second connecting portion has a width less than the length, wherein the second connecting portion has a connection region adjacent to the first extending portion, and wherein the width of the connection region is less than the width of the remaining second connecting portion.

16. The battery pack of claim 10, wherein an edge is formed by at least one of 1) the connection between the second connecting portion and the first extending portion and 2) the connection between the first extending portion and the second extending portion.

17. The battery pack of claim 1, wherein the first connecting portion has i) a top surface at least part of which contacts the first surface of the body portion and ii) a bottom surface at least part of which contacts the first contact pad, and wherein at least about 30% of the bottom surface of the first connecting portion contacts the first contact pad.

18. The battery pack of claim 1, wherein the resistance of the body portion is configured to change based on a temperature of the bare cell.

19. The battery pack of claim 1, wherein each of the body portion and the first connecting portion has a width less than the length, and wherein the length of the body portion is substantially the same as that of the first connecting portion.

20. The battery pack of claim 1, wherein part of the second connecting portion does not contact the second surface of the body portion.
